(19) United States
(12) Patent Application Publication
(10) Pub. No.: US 2010/0154604 A1
(43) Pub. Date: Jun. 24, 2010

(54) Tool with Adjustable Working Angle

(76) Inventor: Cheng-Wei Su, Taichung City (TW)

Correspondence Address: Dr. BANGER SHIA;Patent Office of Bang Shia, 102 Lindencrest Ct., Sugar Land, TX, 77479-5201, US

(21) Appl. No.: 12/500,437

(22) Filed: Jul. 9, 2009

(30) Foreign Application Priority Data
Dec. 22, 2008 (TW) 097150103

(51) Int. Cl. B25B 23/00; B25B 23/16

(52) U.S. Cl. 81/450; 81/177.8

(57) ABSTRACT

A tool with adjustable working angle is provided with a first rod and a second rod which are pivoted to both ends of a connecting member, so the two rods are able to swing with respect to the connecting member. Furthermore, the swing direction of the connecting member with respect to the first rod is the same as the swing direction of the connecting member with respect to the second rod. Hence, through the pivotal motion between the connecting member and the first and second rods, the wrench of the present invention can be adjusted at different working angles so as to adapt to different working environments.

### BACKGROUND OF THE INVENTION

1. Field of the Invention

The present invention relates to a tool, and more particularly to a tool with adjustable working angle.

2. Description of the Prior Art

Hand tool is rich in variety, including screwdriver, hexagonal wrench and etc. FIG. 1 shows a conventional hexagonal wrench 10 which is L-shaped and includes two drive portions (a long drive portion 12 and a short drive portion 13) and a bent portion 11 therebetween. The long and short drive portions 12, 13 are hexagonal in cross section and used to drive fasteners with an inner hexagonal socket (not shown). Such a hexagonal wrench 10 has the following disadvantages:

First, when one of the long and short drive portions 12, 13 of the hexagonal wrench 10 is used as a work head to insert into a fastener with an inner hexagonal socket, the other will serve as operation end to be turned by the user. Since the angle between the long and short drive portions 12, 13 of the hexagonal wrench 10 is fixed and not adjustable, the operation for rotating the fastener might be limited by the fixed angle and cannot be carried out in some particular working environments.

Second, when the short drive portion 13 serves as a work head and the long drive portion 12 is used as a handle turned by the user, since the long drive portion 12 is too long, it may cause inconvenience when the user rotates the hexagonal wrench 10. On the other hand, if the long drive portion 12 serves as a work head while the short drive portion 13 is used as a handle to be turned by the user, since the short drive portion 13 is too short, which means the moment arm is too short, so the user has to user a great effort to turn the wrench.

The present invention has arisen to mitigate and/or obviate the afore-described disadvantages.

### SUMMARY OF THE INVENTION

The primary object of the present invention is to provide a tool with adjustable working angle, which is adjusted in working angle by providing a first rod and a second rod at both ends of a connecting member, respectively.

To achieve the above object, a tool with adjustable working angle in accordance with the present invention comprises:

a connecting member provided at both ends thereof with a first connecting portion and a second connecting portion, respectively, in the first connecting portion being defined a first pivot hole, and in the second connecting portion being defined a second pivot hole;

a first rod provided at one end thereof with a working portion and at the other end thereof with two first clamping portions, each of the first clamping portions being defined with an aligned hole, between the first clamping portions being defined a first slot, the first connecting portion of the connecting member being pivotally connected between the two first clamping portions by a pin inserted through the first holes of the first clamping portions and into the first pivot hole of the connecting member;

a second rod provided at one end thereof with a handle to be turned by a user and at the other end thereof with two second clamping portions, each of the two second clamping portions having an aligned hole, between the second clamping portions being defined a second slot, the second connecting portion of the connecting member being pivotally connected between the two second clamping portions by a pin inserted through the second holes of the second clamping portions and into the second pivot hole of the connecting member.

### BRIEF DESCRIPTION OF THE DRAWINGS

FIG. 1 is a perspective view of a conventional hexagonal wrench;

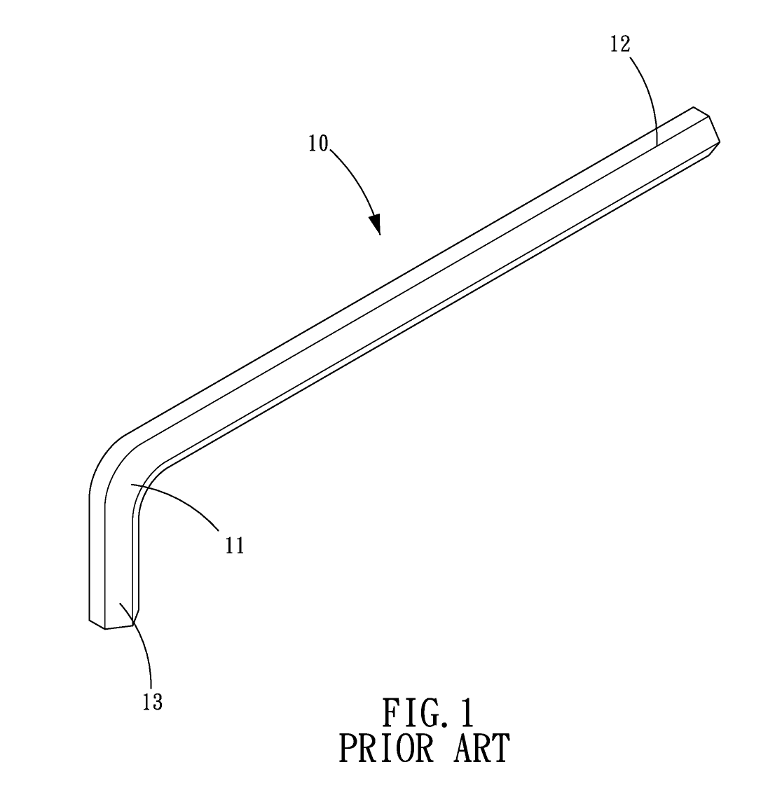

FIG. 2 is an exploded view of a tool with adjustable working angle in accordance with the present invention;

FIG. 3 is an assembly view of the tool with adjustable working angle in accordance with the present invention;

FIG. 4 is an operational view of the tool with adjustable working angle in accordance with the present invention;

FIG. 5 is another view of a tool with adjustable working angle in accordance with the present invention;

FIG. 6 is another view of a tool with adjustable working angle in accordance with the present invention;

FIG. 7 is a perspective view of a tool with adjustable working angle in accordance with another embodiment of the present invention; and

FIG. 8 is a partial cross sectional view of FIG. 7.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

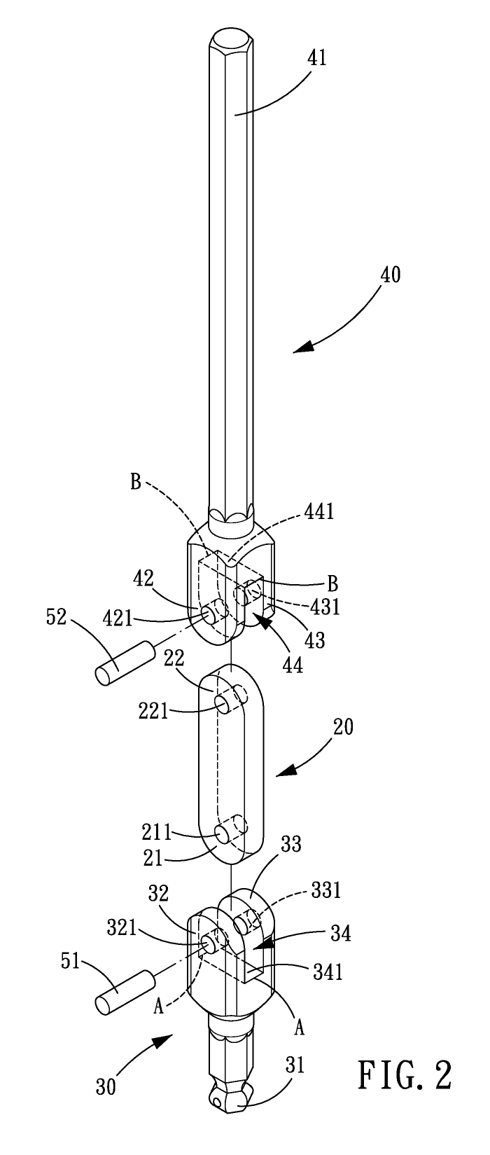

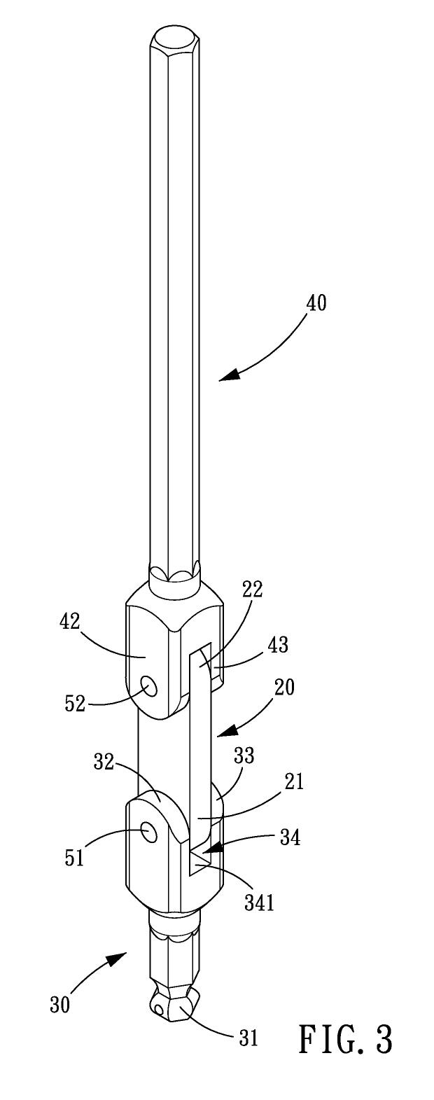

Referring to FIGS. 2 and 3, a tool with adjustable working angle in accordance with the present invention comprises: a connecting member 20, a first rod 30 and a second rod 40.

The connecting member 20 is provided at both ends thereof with a first connecting portion 21 and a second connecting portion 22, respectively. In the first connecting portion 21 is defined a first pivot hole 211, and in the second connecting portion 22 is defined a second pivot hole 221.

The first rod 30 is provided at one end thereof with a working portion 31 which has a hexagonal cross section and is adapted to drive torx key, cross recessed and slot fasteners. At the other end of the first rod 30 are axially provided two first clamping portions 32, 33 each of which has an aligned first hole 321, 331. Between the first clamping portions 32 and 33 is a first slot 34 with a bottom 341, and both ends of the bottom 341 serve as restricting edges A. The first connecting portion 21 of the connecting member 20 is pivotally connected between the two first clamping portions 32, 33 by a pin 51 inserted through the first holes 321, 331 of the first clamping portions 32, 33 and into the first pivot hole 211 of the connecting member 20, so that the first connecting portion 21 can swing within the first slot 34. Furthermore, the swing angle of the connecting member 20 with respect to the first rod 30 is limited by the restricting edges A at both ends of the bottom 341.

The second rod 40 is provided at one end thereof with a handle 41 to be turned by a user, and at the other end of the second rod 40 are axially provided two axial second clamping portions 42, 43 each of which has an aligned second hole 421, 431. Between the second clamping portions 42 and 43 is a second slot 44 with a bottom 441, and both ends of the bottom 441 serve as restricting edges B. The second connecting portion 22 of the connecting member 20 is pivotally connected between the two second clamping portions 42, 43 by a pin 52 inserted through the second holes 421, 431 of the second clamping portions 42, 43 and into the second pivot hole 221 of the connecting member 20, so that the second connecting portion 22 can swing within the second slot 44. Furthermore, the swing angle of the connecting member 20 with respect to the second rod 40 is limited by the restricting edges B at both ends of the bottom 441.

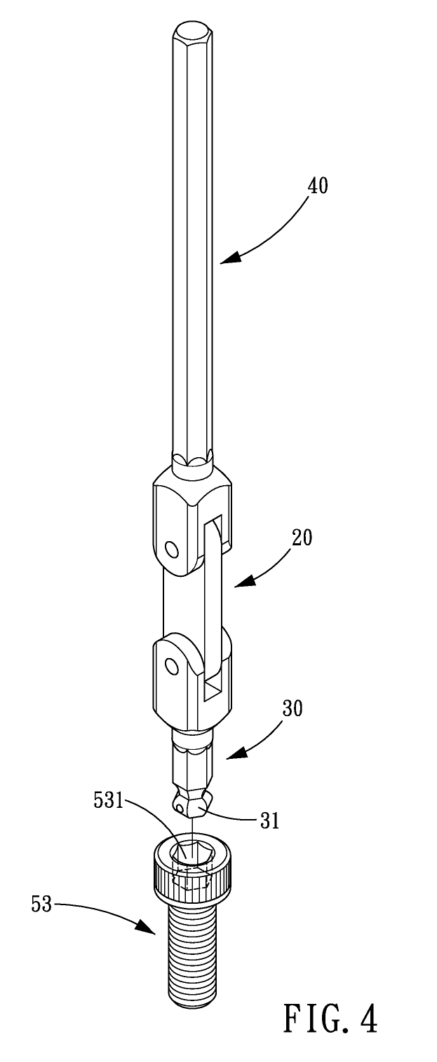

For a better understanding of the present invention, its operation and function, reference should be made to FIG. 4. When the first rod 30, connecting member 20 and the second rod 40 are in the same axial direction, the hexagonal working portion 31 of the first rod 30 can be engaged with a corresponding fastener 53 with in an inner hexagonal socket 531 to rotate it.

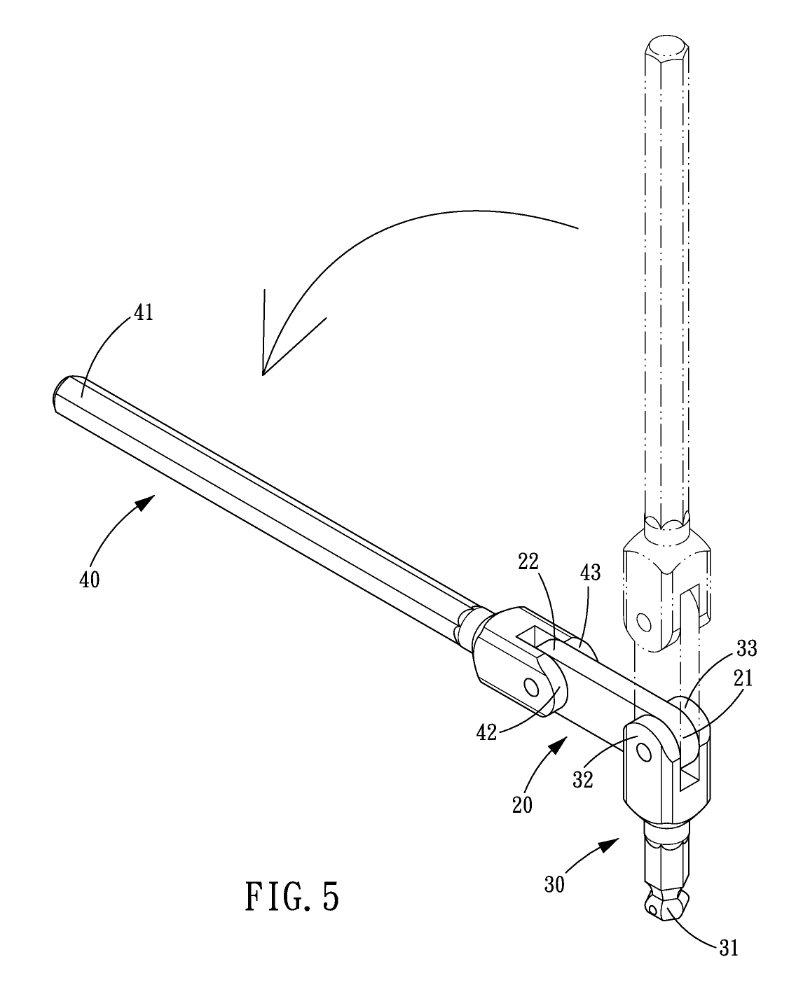

Referring then to FIG. 5, when a relatively large torque is needed during rotation of the fastener, the connecting member 20 can be turned about the first connecting portion 21 and the first clamping portions 32, 33 of the first rod 30 an angle (for example 90 degrees), so as to extend the length of moment arm because at this moment, the total length of the connecting member 20 and the second rod 40 serves as a moment arm. At this moment, the first and second connecting portions 21, 22 of the connecting member 20 are clamped and fixed by the first clamping portions 32, 33 of the first rod 30 and the second clamping portions 42, 43 of the second rod 40, respectively, hence, it can produce a relatively large torque by effortlessly turning the handle 41 of the second rod 40.

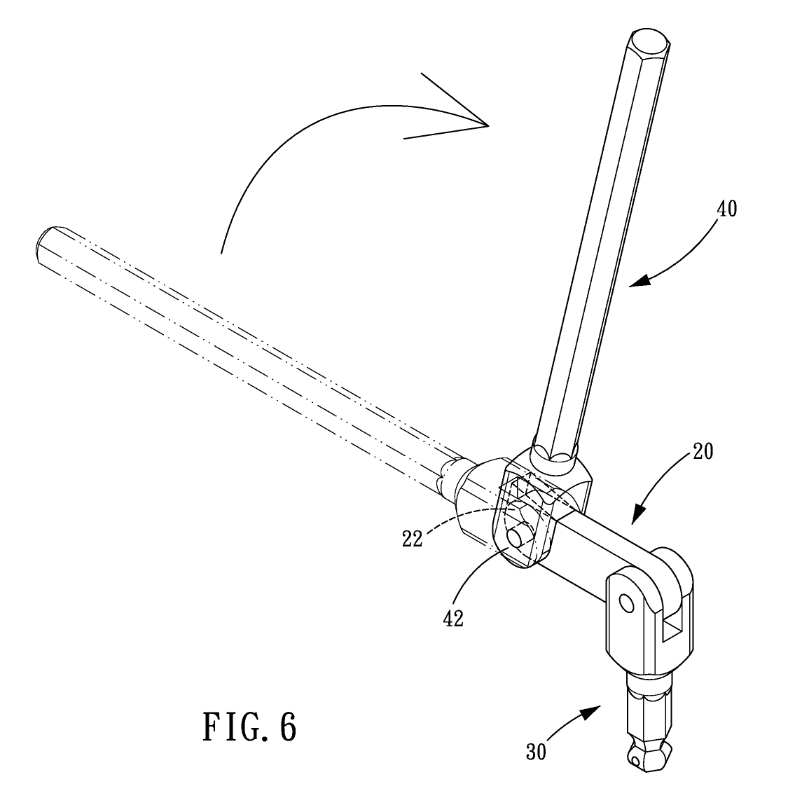

Referring then to FIG. 6, when the wrench of the present invention is used in a small and limited working area, the second rod 40 can be turned a certain angle (77 degrees in this embodiment) about the second clamping portions 42, 43 and the second connecting portion 22 of the connecting member 20, at this moment, the wrench can be used a smallest possible working area and provides a greatest possible torque.

The first and second rods 30, 40 are pivoted to both ends of the connecting member 20, so they are able to swing with respect to the connecting member 20. Furthermore, the swing direction of the connecting member 20 with respect to the first rod 30 is the same as the swing direction of the connecting member 20 with respect to the second rod 40. Hence, through the pivotal motion between the connecting member 20 and the first and second rods 30, 40, the wrench of the present invention can be adjusted at different working angles so as to adapt to different working environments.

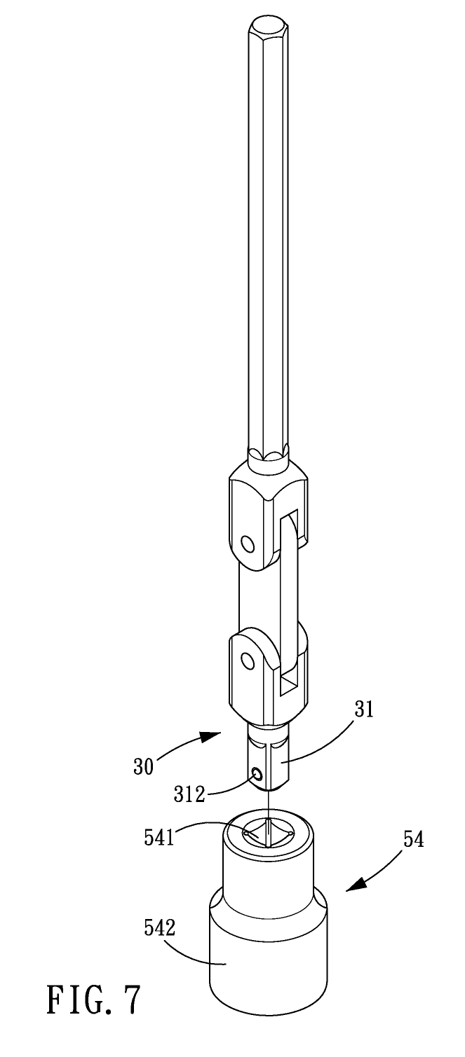

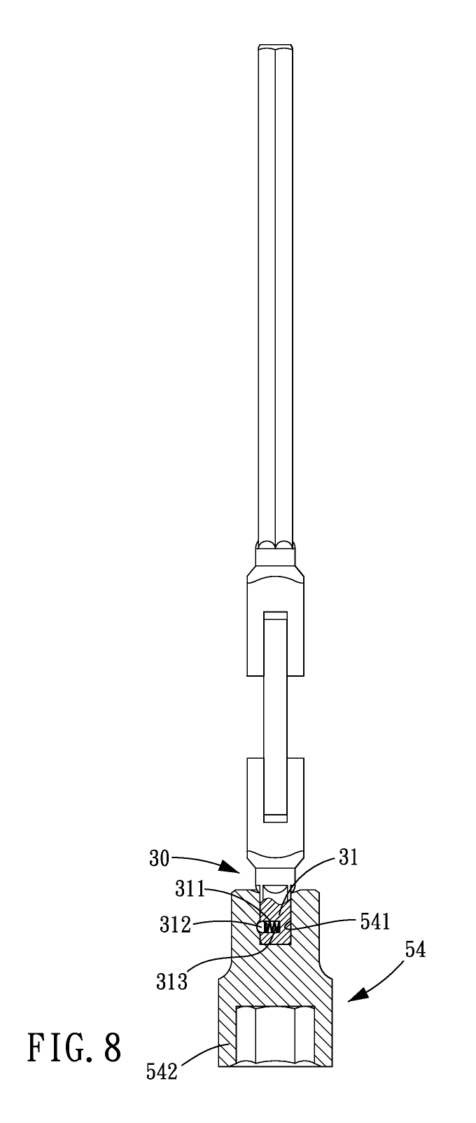

It is to be noted that, as shown in FIGS. 7 and 8, the working portion 31 of the first rod 30 can also be quadrangle in cross section, so it can be engaged with a standard socket 54 with a quadrangle engaging hole 541, and then the work portion 542 can be used to connect different working heads (not shown) or to directly drive fastener. Hence, the applicability of the present invention is improved. Furthermore, the working portion 31 of the first rod 30 is defined with a cavity 311 in which are disposed a steel ball 312 and a spring 313. In normal condition, the steel ball 312 partially protrudes out of the working portion 31, and will completely be sunk into the cavity 311 when it is pressed. Such an arrangement allows the working portion 31 to be connected with the socket 54 more stably.

While we have shown and described various embodiments in accordance with the present invention, it is clear to those skilled in the art that further embodiments may be made without departing from the scope of the present invention.

What is claimed is:

1. A tool with adjustable working angle, comprising:
a connecting member provided at both ends thereof with a first connecting portion and a second connecting portion, respectively, in the first connecting portion being defined a first pivot hole, and in the second connecting portion being defined a second pivot hole;
a first rod provided at one end thereof with a working portion and at the other end thereof with two first clamping portions, each of the first clamping portions being defined with an aligned hole, between the first clamping portions being defined a first slot, the first connecting portion of the connecting member being pivotally connected between the two first clamping portions by a pin inserted through the first holes of the first clamping portions and into the first pivot hole of the connecting member;
a second rod provided at one end thereof with a handle to be turned by a user and at the other end thereof with two second clamping portions, each of the two second clamping portions having an aligned hole, between the second clamping portions being defined a second slot, the second connecting portion of the connecting member being pivotally connected between the two second clamping portions by a pin inserted through the second holes of the second clamping portions and into the second pivot hole of the connecting member.

2. The tool with adjustable working angle as claimed in claim 1, wherein the two first clamping portions are formed in an axial direction of the first rod.

3. The tool with adjustable working angle as claimed in claim 1, wherein the two second clamping portions are formed in an axial direction of the second rod.

4. The tool with adjustable working angle as claimed in claim 1, wherein the working head of the first rod has a hexagonal cross section.

5. The tool with adjustable working angle as claimed in claim 1, wherein the working portion is adapted to drive a fastener which is selected from the group consisting of torx key, cross recessed and slot fasteners.

6. The tool with adjustable working angle as claimed in claim 1, wherein the working portion of the first rod is quadrangle in cross section.

7. The tool with adjustable working angle as claimed in claim 6, wherein the working portion of the first rod is defined with a cavity in which are disposed a steel ball and a spring, in normal condition, the steel ball partially protrudes out of the working portion, and the steel ball will completely be sunk into the cavity when it is pressed.

8. The tool with adjustable working angle as claimed in claim 1, wherein a swing direction of the connecting member with respect to the first rod is the same as a swing direction of the connecting member with respect to the second rod.

9. The tool with adjustable working angle as claimed in claim 1, wherein the first slot of the first rod has a bottom, and both ends of the bottom act as restricting edges to limit a swing angle of the connecting member with respect to the first rod.

10. The tool with adjustable working angle as claimed in claim 1, wherein the second slot of the second rod has a bottom, and both ends of the bottom act as restricting edges to limit a swing angle of the connecting member with respect to the second rod.
